(19) United States
(12) Patent Application Publication
(10) Pub. No.: US 2026/0364555 A1
(43) Pub. Date: Nov. 19, 2026

(54) Packed Bed Reactor

(71) Applicant: Worcester Polytechnic Institute, Worcester, MA (US)

(72) Inventors: Andrew R. TEIXEIRA, Boylston, MA (US); Esai LOPEZ, Santa Teresa, NM (US)

(21) Appl. No.: 18/639,524

(22) Filed: Apr. 18, 2024

Related U.S. Application Data
(60) Provisional application No. 63/460,828, filed on Apr. 20, 2023.

(51) Int. Cl. B01J 8/02

(52) U.S. Cl. CPC B01J 8/0278; B01J 2208/00805

(57) ABSTRACT

A packed bed photochemical reactor ensures a consistent and effective irradiation of light to a reactant volume passed through a reactor. The reactor arranges miniaturized illumination elements such as LEDs in a packed bed arrangement with predetermined gaps or passages between. Fluid in communication with the packed bed flows between these gaps, ensuring a minimum distance to an irradiation source defined by the LEDs. Each LED is wirelessly powered from an inductive field through the reactor from an adjacent coil or electrical source. The inductive field wirelessly powers each of the illumination elements to ensure that the reactant in the passing fluid flow receives a consistent quantity of irradiation energy at the wavelength prescribed by the LED. In this manner, beneficial treatment rates allowing large volumes of reactant can be ensured based on the flow rate through the reactor.

### RELATED APPLICATIONS

This patent application claims the benefit under 35 U.S.C. § 119(e) of U.S. Provisional Patent App. No. 63/460,828, filed Apr. 20, 2023, entitled “PACKED BED REACTOR,” incorporated herein by reference in entirety.

### STATEMENT OF FEDERALLY SPONSORED RESEARCH AND DEVELOPMENT

This invention was made with government support under grant No. 2038257, awarded by the National Science Foundation. The Government has certain rights in the invention.

### BACKGROUND

Photochemistry and photocatalysis define the use and interactions of light emissions for affecting chemical and molecular structures. Modern development of LEDs allows generation of very specific wavelengths of light to be reliably controlled. In many practical applications, such as pharmaceuticals, effective and consistent irradiation of a reactant is important for effective use of photonic based approaches. Establishment of devices and methods that ensure uniform irradiation of a reactant volume enhances implementation and throughput.

### SUMMARY

A photochemical reactor ensures a consistent and effective irradiation of light to a reactant volume passed through a reactor. The reactor arranges miniaturized illumination elements such as LEDs in a packed bed arrangement with predetermined gaps or passages between. Fluid in communication with the packed bed flows between these gaps, ensuring a minimum distance to an irradiation source defined by the LEDs. Each LED is wirelessly powered from an inductive field through the reactor from an adjacent coil or electrical source. The inductive field wirelessly powers each of the illumination elements to ensure that the reactant in the passing fluid flow receives a consistent quantity of irradiation energy at the wavelength prescribed by the LED. In this manner, beneficial treatment rates allowing large volumes of reactant can be ensured based on the flow rate through the reactor.

Configurations herein are based, in part, on the observation that photochemical reactions provide beneficial results for sterilization, testing and production of various reactants. Unfortunately, conventional approaches to photochemical implementations suffer from the shortcomings of inefficiency and imprecision in ensuring that a large volume of reactant consistently receives an effective quantum of irradiation energy. In other words, ensuring that all reactant materials are effectively irradiated with light. Accordingly, configurations herein substantially overcome the shortcomings of conventional approaches by providing a packed bed reactor with wireless illumination elements for passing a reactant flow through substantially uniform perforations, passages or gaps in the packed bed, effectively forming a thin film of the reactant flow as it engages the illumination elements for irradiation of the reactant. The result is a highly effective flow of irradiated reactant passing through the packed bed reactor at sustainably high volumes. The use of the disclosed wireless LED micro-packed beds enables the scaleup of photochemistry for the specialty and fine chemical industries, which otherwise is limited by pressure drop in the small channels needed for light penetration.

In further detail, a packed bed reactor for photochemical treatment of a reactant as disclosed herein includes a vessel adapted to contain a flow of a reactant, and a plurality of illumination elements disposed in the flow. An induction source adjacent to the vessel emits an inductive field, such that the illumination elements are responsive to an inductive coupling with the induction source for irradiating the reactant.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of the packed bed reactor passing a fluid flow of a reactant;

FIGS. 2A-2C are a schematic diagram of the reactor assembly;

FIG. 3 shows an illumination element defined by an LED suitable for use in the reactor assembly of FIGS. 2A-2C;

FIG. 4 shows a biphasic reaction to the reactor assembly of FIGS. 2A-2C on a sample molecule of the reactant;

FIG. 5 shows benefits of flow and treatment efficacy for promoting the biphasic reaction of FIG. 4; and

FIG. 6 shows a comparison with other reactor types.

### DETAILED DESCRIPTION

The use of photocatalytic reactors has been evolving modestly in recent decades, yet such reactors are not widely applied in many industries. The delay in wide use of photocatalytic reactors is suboptimal designs and design limitations. Some of these limitations include overcoming mass transfer limitations (promoting fast adsorption/desorption and increasing catalyst surface area), optimizing photon transfer limitations (optimum lighting and reactor geometry), and integration into industrial systems (scale up and retrofitting into existing systems). Configurations herein demonstrate the use of photocatalytic systems in the visible light spectrum (specifically using wireless LEDs), testing flow and batch methods for various reactants in the reactor.

The scientific principles of light, or photons, on chemical reactions have been evolving for decades. The actions and study of the use of visible or ultraviolet light to influence chemical reactions is generally referred to as photochemistry. There are two laws that dictate photochemistry, the Grotthuss-Draper and the Stark-Einstein laws. The first, Grotthuss-Draper, states that light must be absorbed by a compound for a photochemical reaction to take place. The second, Stark-Einstein, states that for each photon of light absorbed by a chemical system, only one molecule is activated for subsequent reaction.

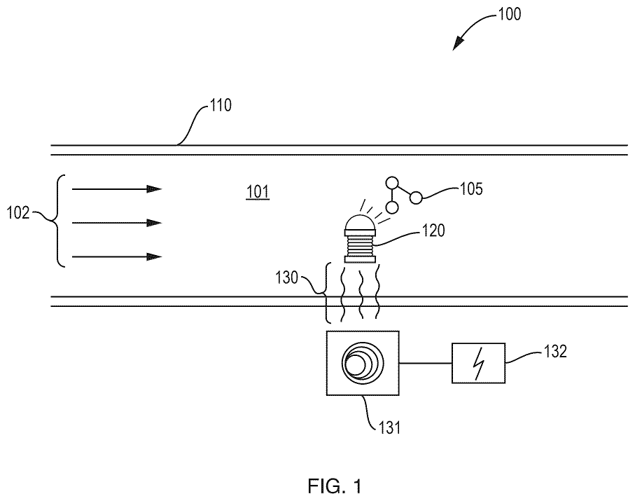

FIG. 1 is a context diagram of the packed bed reactor passing a fluid flow of a reactant. Referring to FIG. 1, a packed bed reactor 100 for photochemical treatment of a reactant 101 includes a vessel 110 adapted to contain a flow 102 of the reactant 101. An illumination element 120 is disposed in the flow 102. An induction source 131 is adjacent to the vessel 110 and powered by an electrical source (voltage or current) 132. The illumination element 120 is responsive to an inductive coupling with the induction source 131 emanating an inductive field 130, for powering the illumination element 120 for irradiating the reactant 101. As described further below, illumination typically includes a plurality of illumination elements 120 disposed in the vessel 110, such that the plurality of illumination elements forms a maximum gap, where the maximum gap defines a fluidic passage for receiving the flow 102 of the reactant 101. Individual molecules 105 of the reactant necessarily pass within a distance not greater than the maximum gap for receiving irradiated light energy from the illumination element 120.

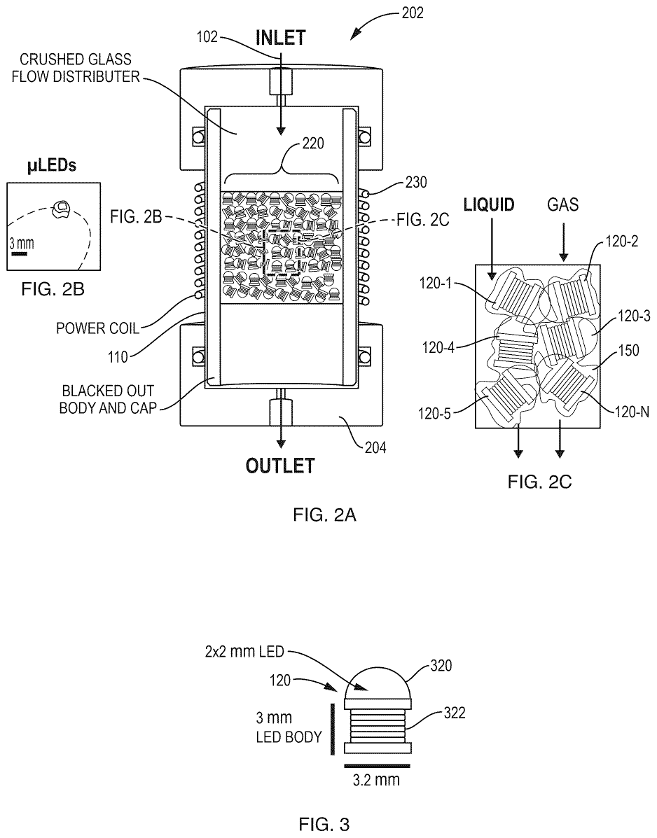

FIGS. 2A-2C are a schematic diagram of a reactor assembly based on the context of FIG. 1. Referring to FIGS. 1 and 2A-2C, a plurality of the illumination elements 120-1 . . . 120-N (120 generally) are disposed in the vessel 110, such that the plurality of illumination elements forms a packed bed 220 arrangement from the close tolerance and alignment of the illumination elements 120. The illumination element 120 therefore includes a plurality of illumination elements 120-N arranged in an adjacency for defining a maximum gap between adjacent illumination elements. The maximum gap effectively defines a thickness of a film 150 of the reactants in the flow during passage through the vessel. The packed arrangement thus defines a space or porosity between the illumination elements through which the reactants pass, where the maximum gap causes the reactant to form the film 150 of maximum thickness as the flow 102 passes between the individual illumination elements 120 of the packed bed 220. The maximum gap therefore sets a distance from the illumination elements 120, where the distance often defines a minimum photonic energy received by the reactant 101 in the flow 102.

The flow 102 is maintained by any suitable pumping source connected to an inlet 202 and an outlet 204 of the vessel. Alternate batch reactor configurations employ a closed configuration, such as suspending the illumination elements 120-N in a stirring arrangement.

In the example configuration, the induction source 131 is an inductive coil 230 surrounding the vessel 110, where the inductive coil 230 is responsive to the electrical source 132 for generating the inductive field 130 in the vessel, and thus the illumination elements 120 are powered by the inductive field 130. Forming the packed bed of illumination elements having no more than the maximum gap between them ensures predictable photonic exposure at high flow rates. In conventional approaches seeking such a short photon-path length, one configuration employed a 0.5 km long photoreactor with a coiled tube configuration. The tube had a 1 mm inside diameter, which imposes a 324.88 psi (2240 kPa) pressure drop. In contrast, the disclosed approach achieves that same <1 mm path length (gap between light source and particles of the reactant 101), but pressure drop (for the same volumetric flowrate) of nearly 0 psi (calculated from Ergun equation). The operating (and capital) costs of pumps are proportional to the pressure they need to supply, hence the improvement allows substantially less pumping capacity to be effective. Calculations used a friction factor of 0.2; 10 ml/min flowrate and fluid properties of water.

FIG. 3 shows an example illumination element defined by an LED suitable for use in the reactor assembly of FIGS. 2A-2C. Referring to FIGS. 103, the illumination elements 120-N further include a light emitting diode (LED) 320, and a conductive coil 322 adapted for receiving inductive energy and connected to the LED. The illumination element 120 is therefore powered from the conductive coil 322 in response to the induction source 131. The LED 320 in the illumination element 120 is inductively coupled to the induction source 131 from the inductive field 130 emitted or induced from the inductive coil 230. The coils 230, 322 form an inductive coupling for a non-contact or wireless powering of the illumination element 120 for irradiating the reactant 101.

In the disclosed approach, by placing the LED 320 lights in the column of the reactor vessel 110, the photon (light) source is in direct contact with the reactant 101. The path length becomes a thin boundary layer or film at the light's surface, allowing for the increased reaction rates. A further advantage is that by employing a packed bed, the flow path of fluids is constantly being churned. Packing the plurality of illumination elements achieves a density for providing a spacing defined by a maximum gap for fluid flow thought the reactor. The packing induces turbulence and lamination of fluids causing a more well mixed systems which are beneficial for biphasic and exothermic systems.

It follows that a size of the illumination elements 120 allows the close tolerances and tight formation to allow formation of the film 150 based the maximum gap. In the example configuration, the illumination elements 120 have a width of 3.2 mm or less and the conductive coil 322 has a length of 3 mm or less. The LED 320 has a size of 2 mm×2 mm or less, thus may be referred to as a micro-LED. Alternate sizing and geometries may be employed, but the disclosed dimensions provide for the film 150 having a thickness of around 29 μm or less. It follows that the maximum gap may be between 20 μm-30 μm. It should be further apparent that the LED 320 and associated electrical connection to the coil 320 is hermetically sealed or otherwise tolerant for withstanding fluid infiltration while immersed in the flow 102.

Additional features may also be derived from the close spacing of the illumination elements 120 in the packed bed 220. The disclosed approach may be further differentiated from conventional approaches by: 1) photocatalyst; the use of coated LEDs for intensifying reaction kinetics is purely covered by this proposed new direction; 2) the extension to a biphasic fluid flow system whereby interfacial mass transfer is promoted in the statically mixed packed bed.

In a particular configuration, the illumination elements are coated with a catalytic material in conjunction with the reactant 101. In recent years, the focus for several catalysts, namely Titania (TiO2), have been looked at largely for their destructive properties on pollutant materials. Titania, for this purpose, has an ultraviolet band in which it degrades certain materials while in the form of an immobilized film or colloidal form. Many of the issues surrounding this material, however, are light distribution and catalyst density. These were substantial factors for considering a coating of Titania for degrading sample chemicals in a flow reactor. Some of the ultraviolet light was also found to escape. Lessening the distance from catalyst to light source as well as increasing reacting surface area are therefore substantial improvements noted from this study on the flow system.

TiO2 is commonly used as a photoreactor, but it cannot effectively absorb visible light, so doped TiO2 alternatives have been developed. These include being doped with copper (Cu), iron (Fe), silver (Ag). Elemental doping can be achieved with many methods including atomic layer deposition. Deposition of the previously mentioned metals onto TiO2 effectively shift wavelength from UV to visible light. Another alternative is to dope the photocatalyst with non-metal elements (like carbon, nitrogen, boron, and sulfur) because metal doped TiO2 has been shown to have decreased photocatalytic performance because the metal acts as an electron trap. Literature has shown that nitrogen doped TiO2 is the most effective in the visible light range.

TiO2 is a widely studied photocatalyst and its related photocatalytic reactions are initiated by the absorption of photons. The electrons in the valence band (VB) are then excited to the conduction band (CB). This leaves a hole in the VB which is strongly oxidizing. It has been found to be beneficial to deposit TiO2 onto supports such as glass beads. Optical fibers have also been used to support TiO2 photocatalysts. This provides a plastic-based support for the TiO2 to be deposited onto. In this procedure, scratched plastic optical fiber woven fabric (POF) is employed, which is comprised of PMMA plastic. The TiO2 was deposited onto the POF using 0.5 weight percent TiO2 in distilled and dipping for 1 minute then drying at 25 °C. This is then repeated 5 or 10 times then the plastic was heat treated at 50 °C for 24 hours. Various coatings and/or dopants may be employed.

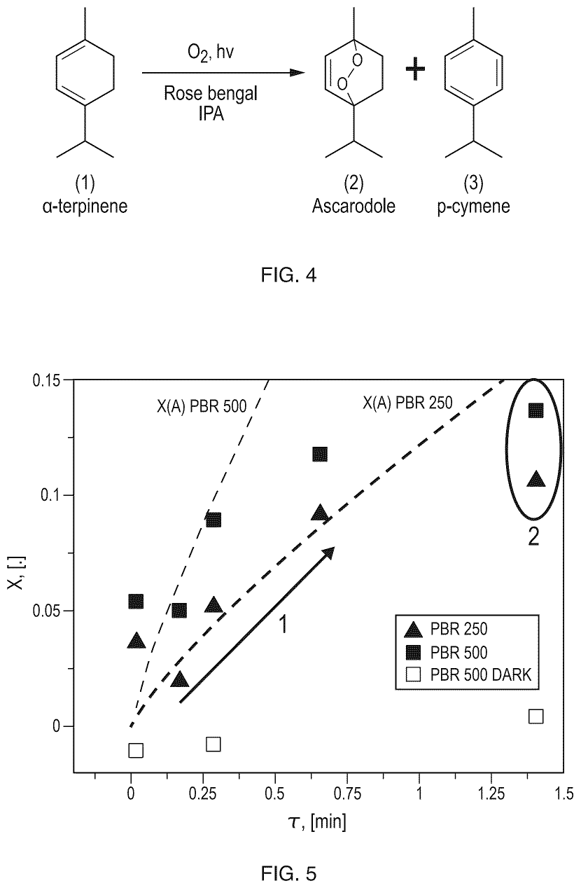

FIG. 4 shows a biphasic reaction to the reactor assembly of FIGS. 2A-2C on a sample molecule of the reactant. Referring to FIGS. 1-4, recall the features discussed above for providing light source (LEDs) packed within a reactor vessel 110 and are fixed in place. The LEDs 320 are adapted for contact with multiphasic reactants (liquid and gas) through the flow 102, as the reactants 101 flow directly over the LEDs creating thin films ~29 μm on the LEDs. The PBR (Packed Bed Reactor) 100 therefore allows for biphasic chemistry-liquid (1) and gas (O2) reactants that require light to form product. The packed bed reactor filled with illuminated LEDs 320 can convert a biphasic chemistry.

FIG. 5 shows benefits of flow and treatment efficacy for promoting the biphasic reaction of FIG. 4. Referring to FIGS. 1-5, consider a conversion (X) used to quantify reactant concentration change:

$$X = 1 - \frac{{C}_{O}}{{C}_{α - terpinene}}$$

The efficacy of the PBR approach can be seen to increasing the contact time (τ) between the LEDs and reactants increases the conversion. Scaling the reactor by increasing the number of LEDs yields to better conversion of the reactant (250 vs. 500 LEDs).

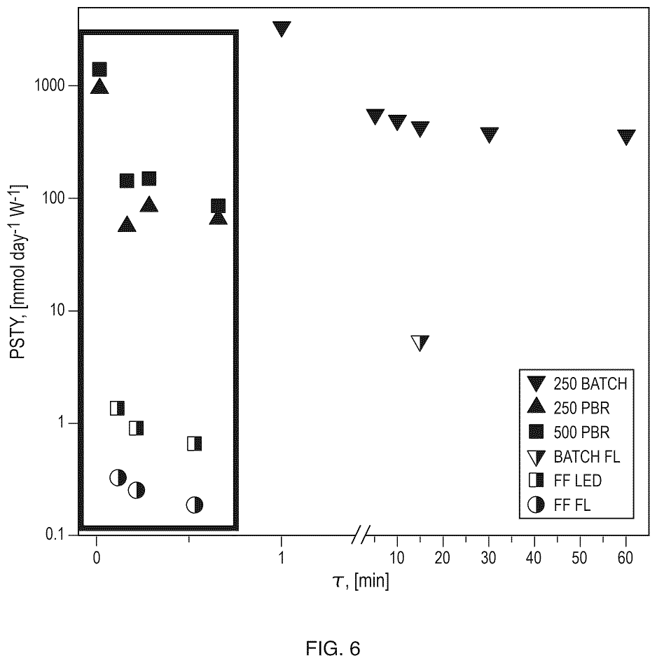

A Photochemical Space-Time Yield (PTSY) can be used to compare the proposed packed bed reactor 100 to other thin film reactors as depicted in FIG. 6:

$$\begin{matrix}Photochemical Space \\ Time Yield ( PTSY )\end{matrix} = \frac{Productivity}{Energy efficiency} = \frac{{C}_{O} \cdot X \cdot {V}_{lit}}{τ \cdot Power}$$

FIG. 6 shows a comparison with other reactor types, such as Batch Fluorescent Light, and Falling Film (FF) LED. Referring to FIG. 6 and Table I, when compared to other reactors of similar design and path lengths the packed bed reactor is more efficient. Reactor throughput is improved by preserving the short photon path length while being able to increase the diameter of the vessel 110 column (scale-out). Since the reactants are in contact with the lights the dimensions of the reactor can be expanded nearly indefinitely without diminishing photon transfer efficiency.

TABLE I

| Reactor Type | Film thickness |
|---|---|
| PBR 250 | 29 |
| PBR 500 | 29 |
| Batch 250 | 15950 |
| Falling film- LED | 41 |
| | 64 |
| | 88 |
| Falling film- Fluorescent Light | 41 |
| | 64 |
| | 88 |
| Schlenk flask batch | 6000 |

The disclosed approach for forming a PBR for photochemical treatment of a reactant can be achieved by disposing a plurality of illumination elements in a vessel 110, and generating a flow 102 of the reactant through the vessel and around the plurality of illumination elements. Formation of an inductive field 130 through the vessel, energizes the illumination elements in response to the inductive field for irradiating the reactant. The indictive field can be formed by wrapping an inductive coil around the vessel 110, and applying a current source to the conductive coil for generating the inductive field.

The disclosed approach is superior to conventional approaches because the use of micro reactors cannot be scaled up dimensionally without inhibiting mass transfer, and the larger reactors are not designed to be operated with catalysts and have removable beds. The LED-PBR is capable of meeting all three needs of industry discussed above. The lights in the reactor can be coated with a catalyst layer. This provides adequate surface area to accelerate photocatalytic reactions. To date none of the commercial flow reactors have utilized packing as a means to support a photocatalyst. The benefits are in both operating and capital costs.

Photons transfer readily occurs since the light source is in contact with the reacting medium and is near catalyst surfaces. The short optical path increase the efficiency because fewer protons are adsorbed to the solvent.

The broader application of photochemistry in industry has been limited by the means to efficiently transfer photons to a well-mixed solution. Much of the work up to this point has been employing microchannel to make sure the entire fluid is irradiated. In doing so, the maximum throughput of a single pass system is limited. Without the disclosed approach, flowrates are limited to those that result in pressures below the bursting limit, with typical reported maximum values of 10 ml/min.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A packed bed reactor for photochemical treatment of a reactant, comprising:
a vessel adapted to contain a flow of a reactant;
an illumination element disposed in the flow; and
an induction source adjacent to the vessel, the illumination element responsive to an inductive coupling with the induction source for irradiating the reactant.

2. The device of claim 1 further comprising a plurality of illumination elements disposed in the vessel, the plurality of illumination elements forming a maximum gap, the maximum gap defining a fluidic passage for receiving the flow of the reactant.

3. The device of claim 1 further comprising a plurality of illumination elements disposed in the vessel, the plurality of illumination elements forming a packed arrangement, the packed arrangement defining a maximum gap through which the reactants pass.

4. The device of claim 3 wherein the maximum gap defines a distance from the illumination elements, the distance defining a minimum photonic energy received by the reactant in the flow.

5. The device of claim 1 wherein the illumination element further comprises a plurality of elements, the plurality of elements arranged in an adjacency for defining a maximum gap between adjacent illumination elements.

6. The device of claim 5 wherein the maximum gap defines a thickness of a film of the reactants in the flow during passage through the vessel.

7. The device of claim 1 wherein the illumination elements further comprise:
a light emitting diode (LED); and
a conductive coil adapted for receiving inductive energy and connected to the LED, the illumination element powered from the conductive coil in response to the induction source.

8. The device of claim 1 further comprising an inductive coil surrounding the vessel, the inductive coil responsive to an electrical source for generating an inductive field in the vessel, the illumination elements powered by the inductive field.

9. The device of claim 1 wherein the illumination element is inductively coupled to the induction source for powering the illumination element for irradiating the reactant.

10. The device of claim 2 wherein the illumination elements have a width of 3.2 mm or less and the conductive coil has a length of 3 mm or less.

11. The device of claim 7 wherein the LED has a size of 2 mm×2 mm or less.

12. The device of claim 6 wherein the film has a thickness of 29 μm or less.

13. A method for photochemical treatment of a reactant, comprising:
disposing a plurality of illumination elements in a vessel;
generating a flow of the reactant through the vessel and around the plurality of illumination elements; and
forming an inductive field through the vessel, the illumination elements responsive to the inductive field for irradiating the reactant.

13. The method of claim 13 further comprising:
wrapping an inductive coil around the vessel; and
applying a current source to the conductive coil for generating the inductive field.

14. The method of claim 13 further comprising:
forming the illumination elements by wrapping a conductive coil around a core, and
connecting the conductive coil to an LED for illuminating the LED in response to the inductive field.

15. The method of claim 13 further comprising packing the plurality of illumination elements for achieving a density for providing a spacing defined by a maximum gap for fluid flow though the reactor.

16. The method of claim 15 wherein the maximum gap is between 20 μm-30 μm.

17. The device of claim 1 wherein the illumination elements are coated with a catalytic material in conjunction with the reactant.
